(19) United States
(12) Patent Application Publication
(10) Pub. No.: US 2012/0086226 A1
(43) Pub. Date: Apr. 12, 2012

(54) PORTION GRIPPER

(75) Inventor: Günther Weber, Gross Nemerow (DE)

(73) Assignee: Weber Maschinenbau GmbH Breidenbach, Breidenbach (DE)

(21) Appl. No.: 13/247,814

(22) Filed: Sep. 28, 2011

(30) Foreign Application Priority Data
Oct. 6, 2010 (EP) 10013381.8

(51) Int. Cl. B25J 15/00; B65G 47/90

(52) U.S. Cl. 294/81.54

(57) ABSTRACT

The disclosure relates to a portion gripper for picking up a product with two blade pans and a drive mechanism for moving the blade pans between a first position, in which the blade pans can be placed down on opposite sides of the product to be picked up onto a support for the product to be picked up, and a second position in which the blade pans are at least partially located under the product to be picked up.

### CROSS-REFERENCES TO RELATED APPLICATION

This application claims priority based on European Patent Application No. 10013381.8, filed Oct. 6, 2010, which is hereby incorporated by reference in its entirety.

### TECHNICAL FIELD

The disclosure relates to a portion gripper for picking up and conveying a food product with at least two blade pans oriented in opposite directions and mounted on a longitudinal guide, which can be moved, by means of a drive means, between an outer ready position and an inner working position in which the food product can be picked up by the blade pans.

### BACKGROUND

Product grippers are basically known and are employed, for example, in the food industry to transfer food products from a first conveying means to a second conveying means, to sort them or to put them into a package. The product grippers are typically mounted to the moving part of a robot.

From GB 2 435 257, a product gripper for food products is known where the blade pans are surrounded by a flexible foil which is to ensure that the food product is picked up gently. The foil is moved in the feed motion of the blade pans which are mounted on a longitudinal guide to achieve a particularly gentle pickup of the food product. This is intended to avoid squeezing.

The Japanese patent publication 2 002 103 268 A describes a product gripper which is to prepare goods to be conveyed for palletizing. In addition to two lateral pivoting blade pans, it comprises two also pivoted stabilizers which are to prevent the product from slipping away when it is picked up, and to prevent the goods to be conveyed from evading laterally during the pressing procedure of the plunger. A plunger arranged above is used to compress the product.

The products to be picked up can be individual pieces or slices, for example of meat, sausage, cheese, ham and the like, or portions composed of several such pieces or slices, respectively. In a portion comprising several slices, the individual slices can be arranged, for example, like shingles. Here, the individual slices do not necessarily have to be arranged like shingles. Here, the individual slices do not necessarily have to lie flatly one upon the other; they can rather also be folded over once or several times, piled or else folded. Usually, such portions consisting of several slices are pushed together manually, i.e. shortened with respect to their length so that they can be inserted into shorter boxes.

### SUMMARY

An object underlying the disclosure is to provide a portion gripper which securely grips a product and simultaneously brings it into a shape adapted to the package.

The disclosure describes a product gripper. Mechanisms for shortening the food product are present in the direction of the longitudinal guide and/or transversely to the latter.

In contrast to the prior art, it is not the primary aim of the disclosed portion gripper to pick up a product free from squeezing or to stabilize it for compression. An object of the disclosed portion gripper is to securely pick up a food portion and compress the food portion to such an extent that the food portion fits into the given geometry of a package.

According to the disclosure, the portion gripper has a double function by taking on, in addition to its original job of gripping a product, the shortening or pushing together of the product.

As the disclosed product gripper does not only grip the product to be handled—for example a portion of several slices—but bundles the product together and also compresses the product. Thus, the product no longer has to be pushed together manually. Instead, the product gripper can insert the picked up and simultaneously shortened product into a corresponding package. As a result, the disclosed product gripper helps to save one manual processing step, whereby product handling or product processing is facilitated and rendered more hygienic and inexpensive.

Advantageous, non-limiting and exemplary embodiments of the invention are described in the description and the drawings.

The means for shortening the product can be constituted such that the product is pushed together in more than one direction, for example in two directions at right angles with respect to each other. A particularly simple structural embodiment can be realized when the shortening means are embodied such that they push together the product in the moving direction of the blade pans.

According to one preferred embodiment, the shortening means are arranged between the blade pans. The shortening means are thus components separate from the blade pans. In this manner, it is basically possible to operate the shortening means independent of the movement of the blade pans.

According to another embodiment, a product to be picked up is pushed together by the blade pans themselves or by holders for the blade pans. In this case, the shortening of the product is coupled to the movement of the blade pans.

The shortening means can be adjusted between a neutral position in which they are at a distance to a product to be picked up, and an active position in which they are in engagement with a picked up product and bundle it together.

For example, the shortening means can comprise two spaced apart flaps which can each be pivoted between a first, at least approximately horizontal position (neutral position), and a second, essentially vertical position (active position) about a pivoting axis which is oriented essentially at right angles to the moving direction of the blade pans.

As an alternative, however, an embodiment is moreover conceivable in which the shortening means comprise two spaced apart, in particular vertically oriented slides which can be shifted between a first position (neutral position) in which they are at a greater distance with respect to each other, and a second position (active position) in which they are at a smaller distance with respect to each other.

According to another embodiment, a coupling mechanism is provided by which the movement of the blade pans from their first position to their second position can be converted to an adjustment of the shortening means from their neutral position to their active position. By the mechanism, the adjustment of the shortening means is coupled to the movement of the blade pans, so that no separate drive for the adjustment of the shortening means has to be provided.

According to a particularly simple structural embodiment, the mechanism comprises rollers connected to the blade pans and beveled edges embodied at the shortening means onto which the rollers can run. This mechanism is particularly suited for the adjustment of shortening means comprising flaps.

Advantageously, locking means for locking the shortening means in their neutral position and/or their active position are provided. The locking means can comprise, for example, magnets.

According to a further embodiment, a plunger for pressing down a picked up product at a deposition place is provided. For example, the plunger can be used to compress a picked up product and introduce it into a package located under it.

Preferably, the plunger can be moved between a lifted ready position, in which a bottom side of the plunger facing the picked up product is spaced apart to the product, and a lowered pressing position, in which the bottom side of the plunger is approximately at the level of a blade pan plane defined by the blade pans, or below it. The stroke of the plunger can be longer than the maximum thickness of a product to be picked up, so that a product to be placed can be effectively pressed into a package disposed below the blade pan plane.

Advantageously, the plunger is disposed between the shortening means. Here, the extension of the plunger, seen in the moving direction of the blade pans, preferably essentially corresponds to the distance of the shortening means in their active position. The shortening means form a channel in which the compressed product is lying and across whose essentially total width the plunger acts on the compressed product, whereby a product to be placed down can be checked and pressed into a package with a uniform distribution of compression.

By shortening means that are locked in their active position it is ensured that a picked up product maintains its shortened total length when it is released.

To be able to release the shortening means from their pressing position, the product gripper preferably comprises a corresponding release mechanism. The release mechanism can comprise magnets provided at the plunger and at the shortening means, the magnets being arranged and polarized such that the magnets of the plunger and the magnets of the shortening means repel each other when the plunger reaches its lowered position. The release of the shortening means from their pressing position is in this manner effected automatically when a picked up product is placed down, in particular when the product to be placed down is completely pressed into its package.

While according to an advantageous embodiment, the shortening means are brought from their ready position to their active position by bringing together the blade pans, the reverse procedure, i.e. the adjustment of the shortening means from their active position to their neutral position, is independent of the movement of the blade pans and can be preferably coupled to the acquisition of the lowered position by the plunger.

In another preferred embodiment, the shortening means comprise two flaps adjustable in the direction of a first longitudinal guide. The flaps are movably connected to each other via double-armed guide bars and preferably have a common actuator.

In the direction transverse with respect to the first longitudinal guide, too, two lockable flaps opposed to each other can be present which are also preferably movably connected to each other by means of a double-armed guide bar. They, too, can be simultaneously moved from a ready position to a working position by means of a preferably common actuator.

The second longitudinal guide for lateral flaps is preferably oriented at a right angle to the first longitudinal guide.

The actual connection between the double-armed guide bars and the flaps is accomplished each via articulated connecting arms.

The blade pans, the flaps, but also the plunger can each individually or together comprise notches for forming fingers. The notches or the fingers, respectively, permit these parts to engage mainly in their respective working position, so that the blade pan and/or the flaps and/or the plunger can overlap. The same possibility is also given for the plunger.

The flaps can have a U- or V-shaped cross-section to shorten the product in the working position of the flaps, that means to compress the product.

### BRIEF DESCRIPTION OF THE DRAWINGS

In the drawings:

FIG. 1 shows, obliquely from the top, a perspective view of a first embodiment of a product gripper with opened blade pans;

FIG. 2 shows a side view of the product gripper of FIG. 1;

FIG. 3 shows a side view of the product gripper of FIG. 1 with semi-closed blade pans;

FIG. 4 shows a side view of the product gripper of FIG. 1 with completely closed blade pans and flaps;

FIG. 5 shows a side view of the product gripper of FIG. 1 with opened blade pans and folded down shortening means;

FIG. 6 shows a side view of the product gripper of FIG. 1 with opened blade pans and lowered plunger;

FIG. 7 shows a perspective view of another embodiment of the invention, where both the blade pans and the shortening means are each in their ready position;

FIG. 8 shows a perspective view of the embodiment of FIG. 7, where both the blade pans and the shortening means have moved towards each other to grip and compress the product;

FIG. 9 shows a perspective view of the embodiment of FIG. 7, where the blade pan and the flaps are in their respective working end position;

FIG. 10 shows a perspective view of the embodiment of FIG. 7, where the blade pans are in their external position and the plunger has moved downwards to insert the product compressed by the lateral flaps downwards into the not represented package;

FIG. 11 shows a perspective representation of the embodiment of FIG. 7, where the flaps and the plunger are also retracted;

FIG. 12 shows a perspective view of the embodiment of FIG. 7, corresponding to the arrangement of the embodiment of FIG. 9, but seen from the bottom;

FIG. 13 shows a bottom view of the second embodiment with the blade pans and flaps being in their working positions, and

FIG. 14 shows a plan view of the second embodiment with a view to the frame structure and the double-armed guide bars mounted therein.

### DETAILED DESCRIPTION

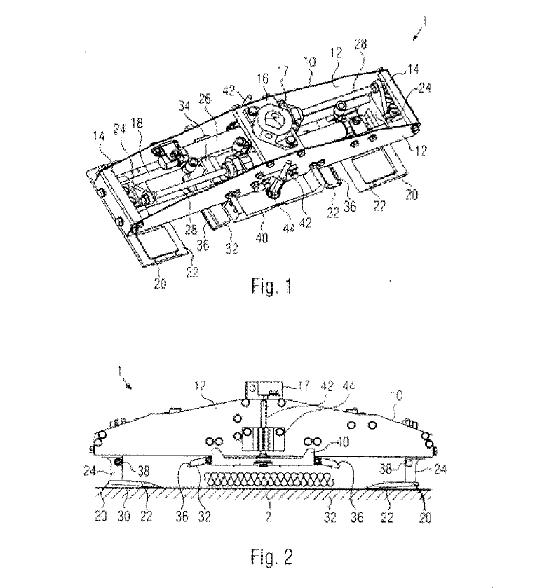

The product gripper 1 of a first embodiment represented in FIGS. 1 to 6 has a frame structure 10 which comprises two spaced apart side plates 12 extending essentially parallel to each other which are connected to each other in the region of their outer ends by two transverse strips 14 and in a central upper region by a cross strut 16. An adapter 17 is attached to the cross strut 16 which permits the assembly of the product gripper at a robot arm.

Two guide rods 18 are fixed to the transverse strips 14 and extend at a distance to each other and parallel to the side plates 12. The guide rods 18 serve to guide two blade pans 20.

Each blade 20 comprises a blade pan 22 which is movably mounted at the guide rods 18 by means of a blade pan holder 24.

To move the blades 20 along the guide rods 18, an actuation cylinder 26, which can be actuated, for example, by a fluid, is associated to each blade 20, the actuation cylinder 26 being arranged above the guide rods 18 and having a piston 28 movable parallel to the guide rods 18, which is, in the region of its free end, connected to the associated blade pan holder 24. The actuation cylinders 26 are supported by the frame structure 10.

It will be understood that basically only one actuation cylinder or a common electric drive can also be provided for moving the blades 20.

By means of the actuation cylinders 26, the blades 20 can be moved between a first position, in which the blade pans 22 have a maximum distance with respect to each other and can be placed at opposite sides of a product 2 to be picked up, for example a portion of piled or folded slices of sausage, ham or cheese, onto a support 30 for the product 2 to be picked up (FIG. 2), and a second position in which the blades 20 have a minimum distance to each other and the blade pans 22 are at least partially located underneath the product 2 to be picked up (FIG. 4).

To shorten the length of a product 2 to be picked up, seen in the moving direction of the blades 20, i.e. to compress the product 2 to be picked up in said direction, two flaps 32 arranged between the blades 20 are pivoted at the frame structure 10, more in detail at respective crossbars 34 extending between the side plates 12 and fixed to it. The corresponding pivoting axes extend at right angles to the guide rods 18 and thus to the moving direction of the blades 20.

The flaps can be each pivoted between a first, at least approximately horizontal position (FIG. 2), and a second, essentially vertical position (FIG. 4). To lock the flaps 32 in their first and second positions, magnets are integrated in the flaps 32 which cooperate in an attracting manner with magnets correspondingly integrated in the crossbars 34.

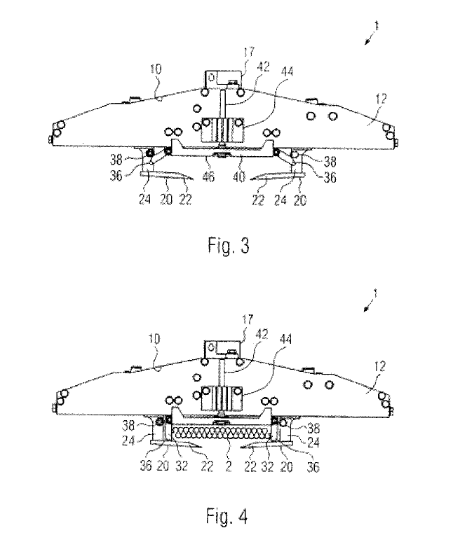

In the region of their free ends, the flaps 32 comprise beveled edges 36 at the side of the blade. At the blade pan holders 24, rollers 38 oriented transversely to the moving direction of the blades 20 are arranged such that the rollers 38 run onto the beveled edges 36 of the flaps 32 located in their first position when the blades 20 are brought together (FIG. 3) and thereby bring the flaps 32 to their second position (FIG. 4).

The length of the flaps 32 is selected such that the free ends of the flaps 32 in the second position of the flaps 32 at least approximately reach the blade pans 22. When the flaps 32 are pivoted to the second position, they consequently engage the product to be picked up and push it together, whereby the length of the product 2 is shortened, seen in the moving direction of the blades 20. The width of the flaps 32, i.e. their dimension seen transverse to the moving direction of the blades 20, at least approximately corresponds to the width of the blade pans 22.

A plunger 40 is arranged between the flaps 32 which, when the flaps 32 are in their second position, extends essentially across the complete distance between the flaps 32. The width of the plunger 40 also at least approximately corresponds to the width of the blade pans 22.

By means of a cylinder not represented in the figures and actuated, for example, pneumatically or hydraulically, the plunger 40 can be moved between a lifted position (FIGS. 1 to 5) and a lowered position (FIG. 6). In the process, the plunger 40 is guided by means of guide members 42 attached to it and extending essentially at right angles to the guide rods 18, the guide members 42 extending through guide elements 44 attached to the outer surfaces of the side plates 12.

The stroke of the plunger 40 is selected such that a bottom side 46 of the plunger 40 facing the blade pans 22 is, in the lifted state of the plunger 40, spaced apart to the upper side of a picked up product, while the bottom side of the plunger 46 is, in the lowered state of the plunger 40, situated somewhat lower than a plane 48 of the blade pan defined by the blade pans 22.

As is represented in FIG. 6, magnets 50 are integrated on the side of the plunger in the region of the free ends of the flaps 32. Magnets 52 are also integrated in the plunger 40 on the side of the flaps which have the same polarity as the magnets 50 of the flaps 32 and are arranged such that, when the plunger 40 is completely lowered, they reach the region 5 of the magnets 50 of the flaps 32. By their identical polarity, the magnets 52 of the plunger 40 and the magnets 50 of the flaps 32 repel each other, whereby the flaps 32 are released from their second position and are folded again to their first position, optionally supported by spring force.

Hereinafter, the functioning of the first embodiment of the product gripper will be illustrated:

Starting from the opened state of the product gripper, in which the blades 20 are in their first position, i.e. are at a maximum distance with respect to each other, the product gripper is lowered to a product to be picked up until the blade pans 22 are placed down on opposite sides of the product on the product support surface 30 (FIG. 2).

By corresponding actuation of the actuation cylinders 26, the blade pans 22 are now moved towards each other and shifted under the product to be picked up. In the process, the rollers 38 of the blades 20 run onto the beveled edges 36 of the flaps 32, whereby the flaps 32 are folded down, i.e. pivoted to their vertical second position, 25, and in the process push together the product to be picked up in the moving direction of the blades 20, i.e. shorten its length (FIGS. 3 and 4).

In this state of the product gripper, the picked up product is transported from its pickup place to a deposition place. Here, the picked up product is fixed by the vertically positioned flaps 32, such that it cannot slip from the blade pans 22.

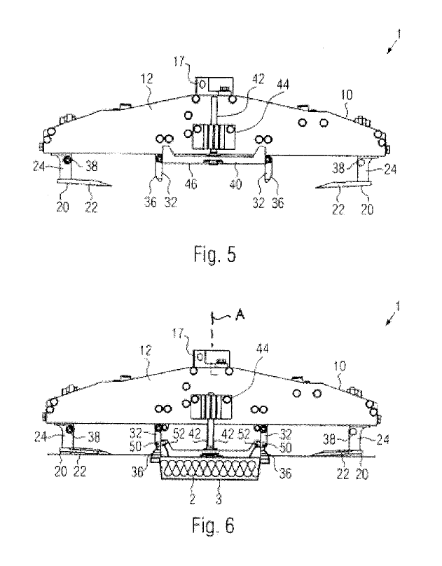

At the deposition place, the product gripper is lowered, and the blades 20 are moved away from each other again by the actuation cylinders 26, i.e. they are opened (FIG. 5). While the blades 20 move away from each other, the flaps 32 remain in a vertical position so that the product maintains its shortened total length when it is released.

Finally, the plunger 40 is lowered to press the product into a package 3 (FIG. 6). As soon as the plunger 40 reaches its deepest position, the flaps 32 are released from their vertical position by the repelling magnets 50, 52, and the flaps 32 pivot again to their horizontal position. The product gripper is now again located in its original state and is ready for picking up a new product.

Although the figures only show a product gripper with shortening means embodied in the form of flaps 32, it should be pointed out that the shortening means can, according to an alternative embodiment, also comprise two spaced apart, in particular vertically oriented slides, which are guided e.g. at the frame structure 10 and can be moved between a first position (neutral position), in which they have a greater distance with respect to each other, and a second position (active position), in which they have a smaller distance with respect to each other.

The movement of the slides towards each other can here be coupled to the movement of the blade pans 22 towards each other or be independent of it.

When a picked up product is placed down, the slides preferably remain locked in their second position until the plunger 40 has pressed the product into a package. That means the blade pans 22 move away from each other without “taking the slides along” in the process.

Only with the subsequent upward movement of the plunger, the slides would then move again back to their first position. Here, it is conceivable that not only the locking of the slides by the lowered plunger is released, but that the moving of the slides away from each other is altogether coupled to the upward movement. However, a separate drive can of course be provided for the slides which permits the slides to move away from each other independent of the plunger movement.

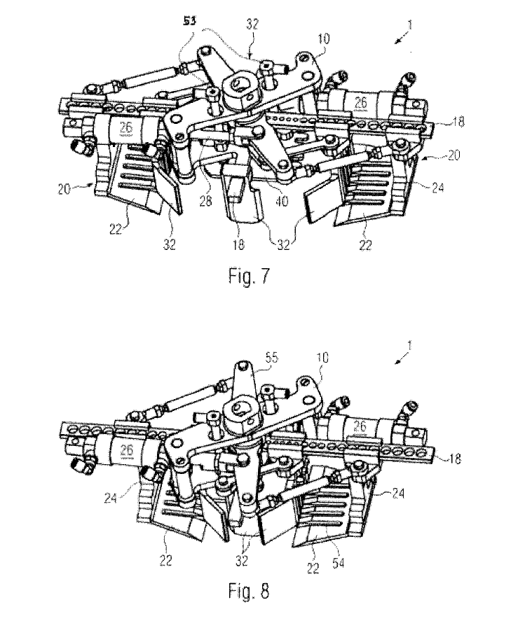

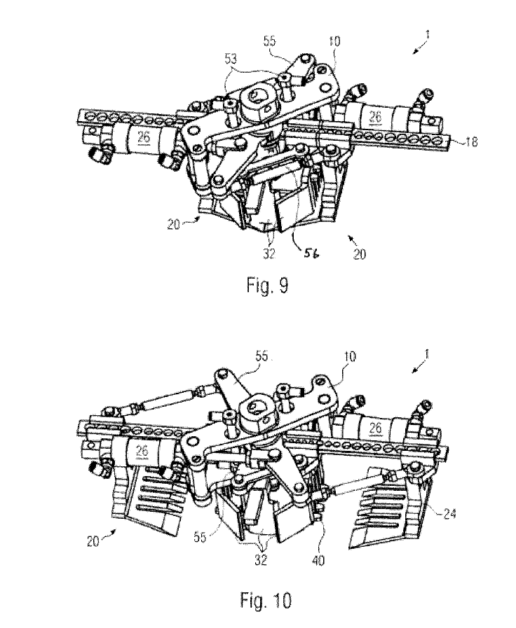

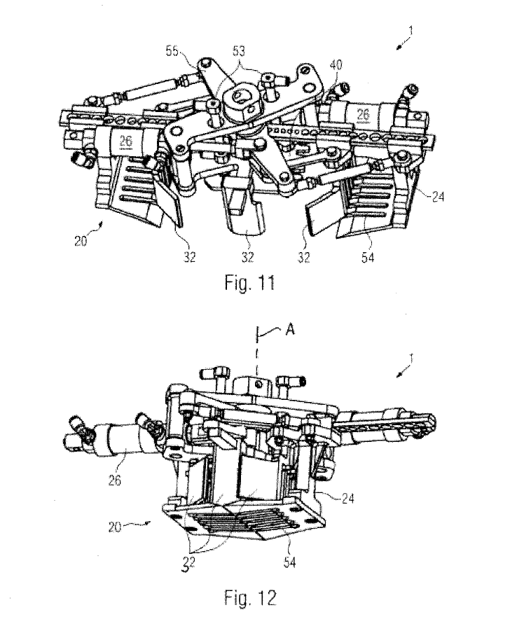

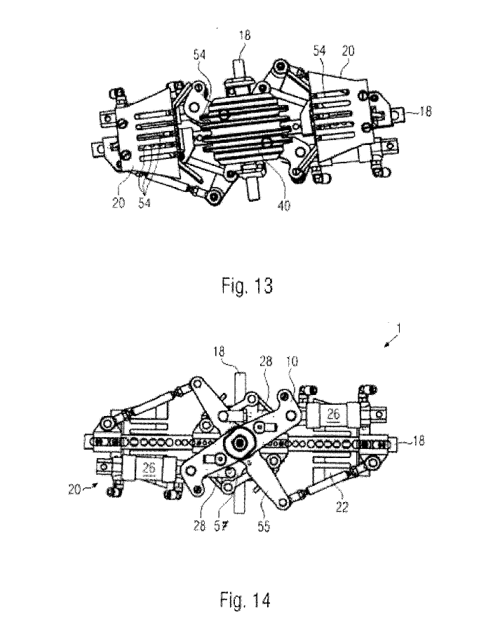

The other embodiment of the invention according to FIGS. 7 to 14 relates to a gripper 1 for a robot which can pick up food products 2 to subsequently place them in a package 3. The food products 2 are cut products, such as cut sausage or ham products. These products are placed onto a conveying belt in a relatively unshaped and piled up state. It occurs in the process that the products occupy more area on the conveying belt than is available for them in the package. The products are therefore bundled together when they are picked up by the gripper, so that they subsequently fit into the package.

The gripper 1 preferably compresses the products in two directions, so that they are reduced in size in their complete extension. They are pushed together in and/or transverse to the conveying direction.

The gripper 1 pushes the product 2 together such that it is smaller than the area it can cover in the package 3. By depositing the product in the package 3, the product expands somewhat again so that the package 3 is finally optimally filled.

The movement for compressing the product 2 is effected nearly at the same time as the pickup movement of the blades 20. Here, it is conceivable to first compress the product and subsequently completely grip under it with the blades. However, it is also conceivable to pick up the product and to completely grip under it and subsequently compress it. Gripping under it and compressing it can also be done nearly simultaneously.

Compression or a reduction of the area is accomplished, for example, with the following ratio: before the product is pushed together: length: approximately 160 mm, width: approximately 112 mm; after the product has been pushed together: length: approximately 104 mm, width: approximately 98 mm. These values are only one example that can vary in any direction. The product does not always have to have the same extension after cutting.

The movements of the individual flaps 32 and blades 20 can be effected depending on each other, or else independent of each other.

Three cylinders 26 can be provided as actuators for the blades 20, flaps 32 and the plunger 40.

A first double guide bar 55 is pivoted at the frame structure 10 about a vertical axis A, which is movably connected on the one hand via connecting arms 56 with both blades 20, and on the other hand via a piston rod 28 with an actuator 26. If the actuator 26 is activated, the double guide bar 55 is pivoted about its axis. Together with it, the opposed blades 20 are shifted on the longitudinal guide 18.

A second double guide bar 57 is also pivoted about the vertical axis A at the frame structure 10. It is located underneath the already mentioned double guide bar 55 which can adjust the blades 20. The double guide bar 57 serves to adjust the flaps 32 and is to this end connected to a further actuator 26 which is in turn movably connected to this double guide bar 57 via a piston rod 28. The latter also has connecting arms 56 as a link to the flaps 32.

Two flaps 32 each are arranged in front of the blades 20 and arranged on the longitudinal guide 18 to be shifting together with them. Two further flaps 32 are arranged laterally and movably mounted on a second longitudinal guide 18 oriented transverse to the first longitudinal guide 18. The already mentioned double guide bar 57 and the common actuator 26 together act on them, as on the other flaps.

A non-depicted actuator moves the plunger 40 via vertical rods 53, the plunger moving the product 2 securely from the gripper 1 in the direction towards the package 3. It presses the product 2 towards the package 3 while the flaps still hold it in its compressed state. It is thus ensured that the product 2 only expands again in the package and after the gripper 1 has left it and thus takes an optimal place in the package 3.

The blades 20 are preferably simultaneously moved with their front ends under the flaps 32. By this, a partial slipping of the product 1 under the flaps 32 during the compression is prevented.

The blades 20, flaps 32 and plungers 40 each engage with fingers which result from notches 54. They prevent food remainders possibly pinched from being left.

1. A portion gripper for picking up and conveying a food product with at least two blade pans oriented in opposite directions and mounted on a longitudinal guide, which can be moved by at least one drive mechanism between an outer ready position and an inner working position, wherein the food product can be picked up by the blade pans,
characterized in that
shortening flaps for shortening the food product in the direction of the longitudinal guide or transverse to the latter are present.

2. The portion gripper according to claim 1,
characterized in that
the shortening flaps are on longitudinal guides and are adjustable.

3. The portion gripper according to claim 1,
characterized in that
the shortening flaps are between the blade pans.

4. The portion gripper according to claim 1,
characterized in that
the shortening flaps are adjustable between a neutral position in which they are not engaged with a product to be picked up, and an active position in which they are engaged with a picked up product.

5. The portion gripper according to claim 1,
characterized in that
the shortening flaps comprise at least two spaced apart opposed flaps which can each be pivoted about a pivoting axis between a first, at least approximately horizontal ready position, and a second, essentially vertical working position which is oriented essentially at right angles to the moving direction of the blade pans.

6. The portion gripper according to claim 1,
characterized in that
a device is provided by which the movement of the blade pans from their first position to their second position can be converted to an adjustment of the shortening flaps from their neutral position to their active position.

7. The portion gripper according to claim 6,
characterized in that
the device comprises rollers connected to the blade pans and beveled edges embodied at the shortening flaps onto which the rollers run.

8. The portion gripper according to claim 1,
characterized in that
the shortening flaps are lockable in one or both of their neutral position and their active position.

9. The portion gripper according to claim 1,
characterized in that
the shortening flaps are lockable by magnets.

10. The portion gripper according to claim 8,
further comprising
a release mechanism for the lockable shortening flaps.

11. The portion gripper according to claim 1,
further comprising
a plunger for pressing down a picked up portion.

12. The portion gripper according to claim 11,
characterized in that
the plunger can be moved between a lifted position in which a bottom side of the plunger facing the picked up portion is at a distance to the portion, and a lowered position in which the plunger's bottom side is approximately at the height of a blade pan plane defined by the blade pans or below.

13. The portion gripper according to claim 11,
characterized in that
the plunger is between the shortening flaps, wherein extension of the plunger essentially corresponds to the distance of the shortening flaps in their active position.

14. The portion gripper according to claim 10,
characterized in that
the release mechanism comprises magnets at the shortening flaps and at the plunger, which are arranged and polarized such that the magnets of the shortening flaps and the magnets of the plunger repel each other when the plunger reaches its lowered position.

15. The portion gripper according to claim 1,
characterized in that
the shortening flaps comprise at least two flaps adjustable in the direction of the longitudinal guide or at least two flaps adjustable in the direction transverse.

16. The portion gripper according to claim 15,
characterized in that
the adjustable flaps each facing each other are movably connected to each other via a double-armed guide and comprise an actuator.

17. The portion gripper according to claim 11,
characterized in that
the blade pans or the flaps or the plunger comprise fingers between notches.

18. The portion gripper according to claim 15,
characterized in that
the flaps adjustable in the direction of the longitudinal guide of the blade pans are mounted on the longitudinal guide of the blade pans or the latter are formed towards the center of the product gripper in the shape of a U or a V.
